(19) United States
(12) Patent Application Publication
(10) Pub. No.: US 2014/0082002 A1
(43) Pub. Date: Mar. 20, 2014

(54) APPARATUS AND METHOD FOR PROCESSING UNSTRUCTURED DATA EVENT IN REAL TIME

(71) Applicant: Electronics and Telecommunications Research Institute, Daejeon-si (KR)

(72) Inventors: Nac-Woo KIM, Seoul (KR); Hong-Yeon YU, Gwangju-si (KR); Jae-In KIM, Gwangju-si (KR); Byung-Tak LEE, Suwon-si (KR); Young-Sun KIM, Daejeon-si (KR)

(21) Appl. No.: 13/911,219

(22) Filed: Jun. 6, 2013

(30) Foreign Application Priority Data
Sep. 20, 2012 (KR) 10-2012-0104645

(51) Int. Cl. G06F 17/30

(52) U.S. Cl. CPC G06F 17/3061
USPC 707/755

(57) ABSTRACT

An apparatus for processing an unstructured data event in real time is provided. The apparatus includes a feature extraction unit configured to extract predetermined feature data of unstructured data output from a plurality of unstructured data sensors, a metadata forming unit configured to form the feature data of the unstructured data collected by the feature extraction unit as metadata including all attributes of the structured data and the unstructured data, a metadata parser unit configured to parse the metadata formed by the metadata forming unit, and an event processing unit configured to process event generation defined by a result of parsing in the metadata parser unit.

### CROSS-REFERENCE TO RELATED APPLICATION

This application claims the benefit under 35 U.S.C. §119(a) of a Korean Patent Application No. 10-2012-0104645, filed on Sep. 20, 2012, the entire disclosure of which is incorporated herein by reference for all purposes.

### BACKGROUND

1. Field

The following description relates to an apparatus and method for processing an event of an unstructured data that is not structurized in a specific format in real time, in an apparatus for processing an event of data in real time.

2. Description of the Related Art

Recently, online social services and large-capacity multimedia services based on a high-speed network are rapidly developed. Data generated by such online social services and large-capacity multimedia services are unstructured data that are not structurized in a specific format. These large-capacity unstructured data are continuously generated online as well as in the field of each industry such as finance, communication and power. Accordingly, an interest in processing of such unstructured data has greatly increased. In addition, real-time information parsing and processing are not easy due to a large amount of data.

Meanwhile, an event processing scheme of extracting/parsing only meaningful information from among numerous structured data generated in a various industrial/home sensors in real time, defining a specific event generation condition, and processing the event has recently attracted attention. It is necessary to form metadata from the structured data in order to process such an event. Meanwhile, there have been many efforts to apply such an event processing scheme to the unstructured data. However, general structured data has attributes according to a purpose of each data such as name, sex and age whereas the unstructured data has no specific attributes and format. Thus, since multimedia-based unstructured data has no specific attributes, a range of provision of stored files and metadata in streaming is limited. Further, when any of various large-capacity data generation devices is considered as a kind of image sensor or unstructured data sensor device, there are problems in that compatibility and synchronization between structured data and unstructured data should be solved, and in the case of image data, selection of an appropriate feature vector and an object description in an image should be realized, in order is to drive a complicated event processing device on a system for real-time processing of sensor information.

### SUMMARY

Therefore, the present invention provides an apparatus and method for processing an event through metadata structurization for large-capacity data that is not structurized or large-capacity unstructured multimedia data in an image sensor, such as an image or a video in real time.

In one general aspect, an apparatus for processing an unstructured data event in real time includes: a feature extraction unit configured to extract predetermined feature data of unstructured data output from a plurality of unstructured data sensors; a metadata forming unit configured to form the feature data of the unstructured data collected by the feature extraction unit as metadata including all attributes of the structured data and the unstructured data; a metadata parser unit configured to parse the metadata formed by the metadata forming unit and continuously extract sensing data generated by the same sensor; and an event processing unit configured to select only data corresponding to a predetermined rule from among the sensing data extracted by the metadata parser unit to generate an event.

In another general aspect, a method of processing an unstructured data event in real time includes extracting predetermined feature data of unstructured data output from a plurality of unstructured data sensors; forming the feature data of the unstructured data as metadata including all attributes of the structured data and the unstructured data; parsing the formed metadata; and processing event generation defined by a result of the parsing.

### BRIEF DESCRIPTION OF THE DRAWINGS

FIG. 1 is a diagram illustrating a configuration of an apparatus for processing an unstructured data event in real time according to an embodiment of the present invention;

FIG. 2 is a diagram illustrating a structure of metadata for event processing according to an embodiment of the present invention;

FIG. 3 is a diagram illustrating time code structurization mapping of unstructured data according to an embodiment of the present invention;

FIGS. 4A and 4B are illustrative diagrams illustrating a structure of metadata of unstructured multimedia data; and

FIG. 5 is a flowchart illustrating a method of processing an unstructured data event in real time according to an embodiment of the present invention.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, the present invention according to a preferred embodiment will be described in detail with reference to the accompanying drawings.

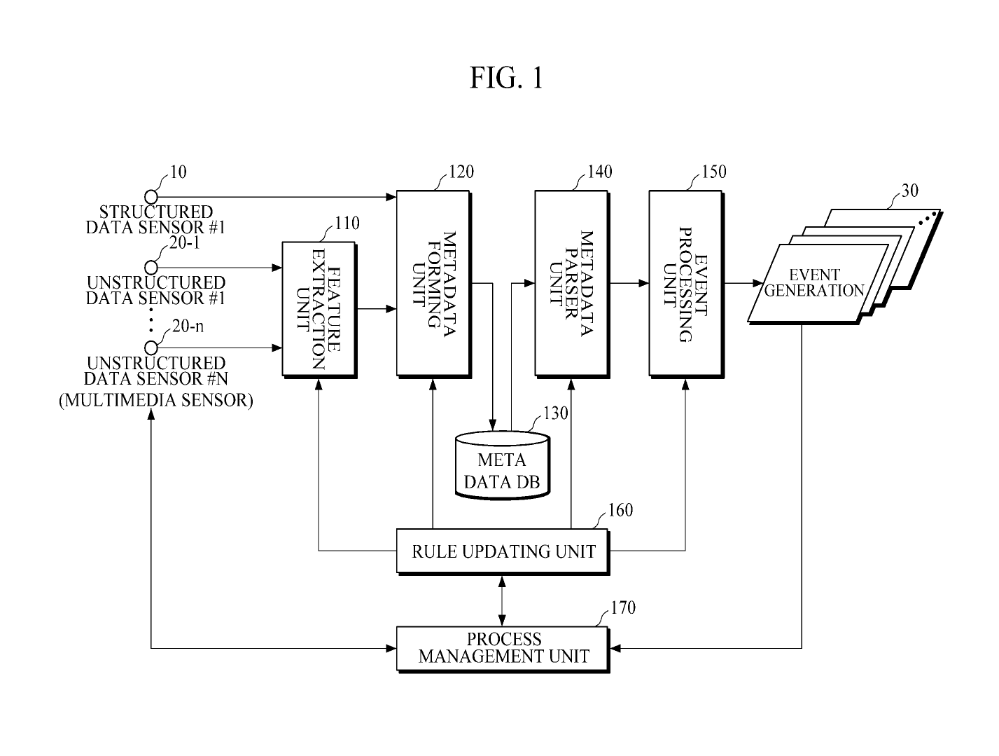

FIG. 1 is a diagram illustrating a configuration of an apparatus for processing an unstructured data event in real time according to an embodiment of the present invention.

Referring to FIG. 1, an apparatus for processing an unstructured data event in real time according to an embodiment of the present invention includes a feature extraction unit 110, a metadata forming unit 120, a metadata database (DB) 130, a metadata parser unit 140, and an event processing unit 150. In addition, the apparatus for processing an unstructured data event in real time may further include a rule updating unit 160 and a process management unit 170.

A structured data sensor 10 is a sensor that generates structured data, such as a temperature/humidity sensor. In the case of a general industrial/home sensor that is the structured data sensor 10, one or two numerical data per second are generated. In a device needing exact measurement such as a power sensor, tens to hundreds of numerical data per second are generated, and several Kbyte data amount is generated daily.

A plurality of unstructured data sensors 20-1, . . . , and 20-n are sensors that generate data that is not structurized in a specific format, such as social network service (SNS) data such as blog or Twitter data and data of a sporadic web article. In the case of such unstructured data, data of tens to hundreds of Mbytes are generated at a time and, in the case of a high definition (HD) video, compressed data of tens of Mbytes of a large-capacity multimedia stream are generated in real time.

The feature extraction unit 110 first extracts a unique feature in order to structurize the unstructured data output from the plurality of unstructured data sensors 20-1, . . . , and 20-n. Such a feature includes an attribute value such as a keyword or a tag in the web article or a color, a boundary, feel of a material, a position, a motion or the like in the multimedia data. In this case, the feature extraction is frequently updated by the rule updating unit 160 for processing using an extracting method set in advance or a method defined by a user through an external interface.

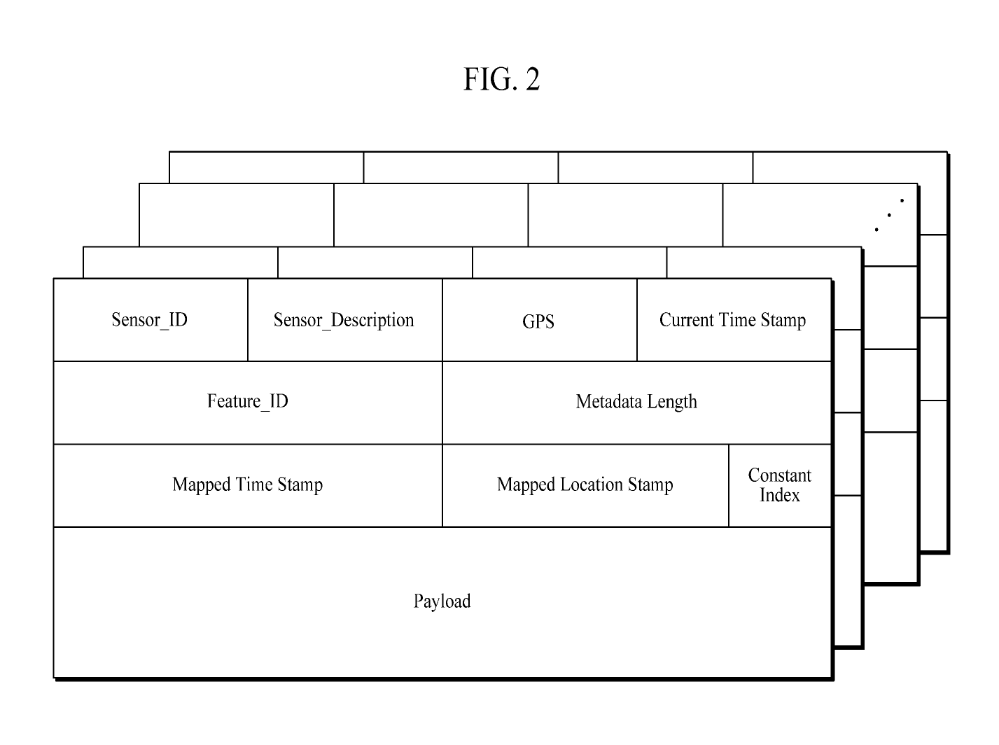

The metadata forming unit 120 selects primary data from each of the feature data of the unstructured data collected by the feature extraction unit 110 and the structured data output from the structured data sensor 10 to form metadata. Here, the metadata is formed so that real-time event processing is possible by representing all attributes of the structured data and the unstructured data. However, since the unstructured data includes many overlap data, data is extracted/summed up not to overlap such that a number of overlap metadata are not generated. In addition, the metadata forming unit 120 forms the metadata by regularly changing a generation period of time code of the unstructured data to be synchronized with time code of the structured data and causing overlap data to have the same time code by describing multi attribute values of the overlap data in a payload. A detailed structure of the metadata will be described below with reference to FIG. 2.

The formed metadata may be transmitted to another network device in a packet format over a network, and may be stored in the metadata DB 130. Alternatively, the metadata may be delivered to the event processing unit 150 in real time.

The metadata parser unit 140 extracts the metadata from the metadata forming unit 120 or the metadata DB 130, parses the metadata, and inputs a parsing result to the event processing unit 150. In other words, the metadata parser unit 140 parses the metadata transmitted from the DB in the same apparatus or from a remote apparatus in real time, continuously extracts only sensing data generated in the same sensor, and inputs the sensing data to the event processing unit.

The event processing unit 150 performs a process of generating an event corresponding to the parsing result output from the metadata parser unit 140. In other words, the event processing unit 150 serves to select only data corresponding to a predetermined rule from among the input sensing data according to a previously input processing rule, and generate the event.

The rule updating unit 160 registers or updates a predetermined criterion for extraction of the feature data in the feature extraction unit 110. The rule updating unit 160 also registers or updates a predetermined criterion for selection of the primary data from among the extracted feature data in the metadata forming unit 120. The rule updating unit 160 also registers or updates a parsing rule for parsing of the metadata in the metadata parser unit 140. The rule updating unit 160 also registers or updates an event processing rule defined according to the result of parsing the metadata in the event processing unit 150.

The process management unit 170 performs On/Off setting of a feature extraction scheme of the feature extraction unit 110 through the rule updating unit 160, updates a mapped time stamp/mapped location stamp table of the metadata forming unit 120, and controls a data flow. Further, the process management unit 170 registers each sensor and controls the sensor through analysis when an event occurs.

FIG. 2 is a diagram illustrating a structure of the metadata for event processing according an embodiment of the present invention.

Referring to FIG. 2, the metadata include all attributes of the structured data and the unstructured data.

Attribute information of the structured data includes sensor ID, sensor_description, GPS, and current time stamp. Attribute information of the unstructured data includes feature_ID, mapped time stamp, mapped location stamp, constant index, payload, and metadata length.

The sensor ID is an ID for identifying the structured data sensor and the is unstructured data sensor. The sensor_description is a description of a function of the sensor, such as a temperature sensor or a humidity sensor. The GPS is information of a position in which the sensor is located, and is a GPS coordinate. The current time stamp is a time when data generated by the sensor is actually input.

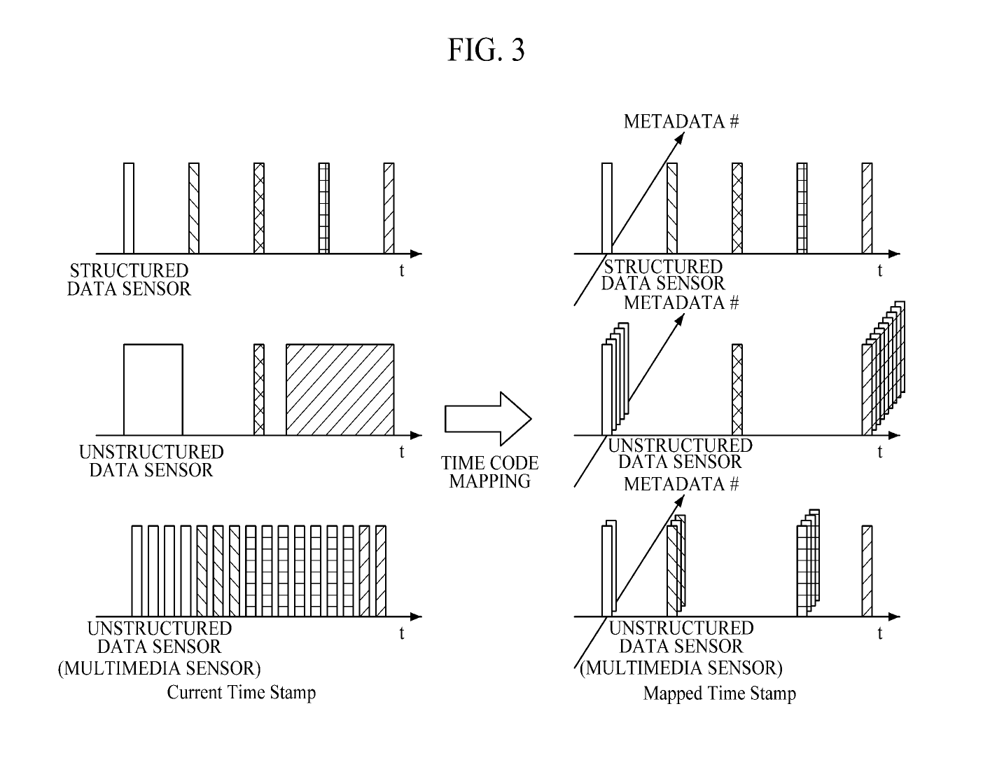

The feature_ID is information for identifying the extracted feature, and refers to a unique ID representing an attribute descriptor such as a keyword or a tag in a web article, and a feature descriptor such as a color, a boundary, feel of a material, a position, or a motion in multimedia data. The mapped time stamp is information for synchronizing a data indication time of the structured data with a data indication time of the unstructured data. This will be described below in greater detail with reference to FIG. 3.

The mapped location stamp indicates a position value of feature_ID in the unstructured data of a multimedia format.

The constant Index indicates continuity of the metadata. The constant Index is intended to indicate the continuity of a plurality of metadata when the plurality of metadata are generated in the same mapped time stamp, and indicates continuous metadata as “1” and discontinuous metadata as “0.” For example, the constant Indexes in five metadata that are continuous in the same time are indicated as “1,” “1,” “1,” “1” and “0” in the respective metadata.

In the payload, a single attribute (feature) value or multi attribute (feature) values may be indicated and are described with start/end indicators. End of the payload is recognized by the metadata length. Further, there are, for example, a payload for indicating a real data attribute, and an additional metadata length indicating a total length of the metadata.

FIG. 3 is a diagram illustrating time code structurization mapping of the unstructured data according to an embodiment of the present invention.

Referring to 3, a generation period of the structured data is regular, and a generation period of the unstructured data is irregular. Further, a size of the structured data is constant and a size of the unstructured data is not constant. Meanwhile, in the case of multimedia data, a generation period of the multimedia data is regular, but the multimedia data is very frequently generated such that the same data is repeatedly generated.

According to an embodiment of the present invention, the metadata forming unit 120 performs a transform process on the unstructured data so that the data is periodically generated in the same form as the structured data. First, the metadata forming unit 120 regularly changes a generation period of time code of the unstructured data to be synchronized with the time code of the structured data, and causes overlap data to have the same time code by describing multi attribute values of the overlap data in the payload. In this case, the metadata forming unit 120 deletes the overlap data of the unstructured data through a main data sum-up scheme.

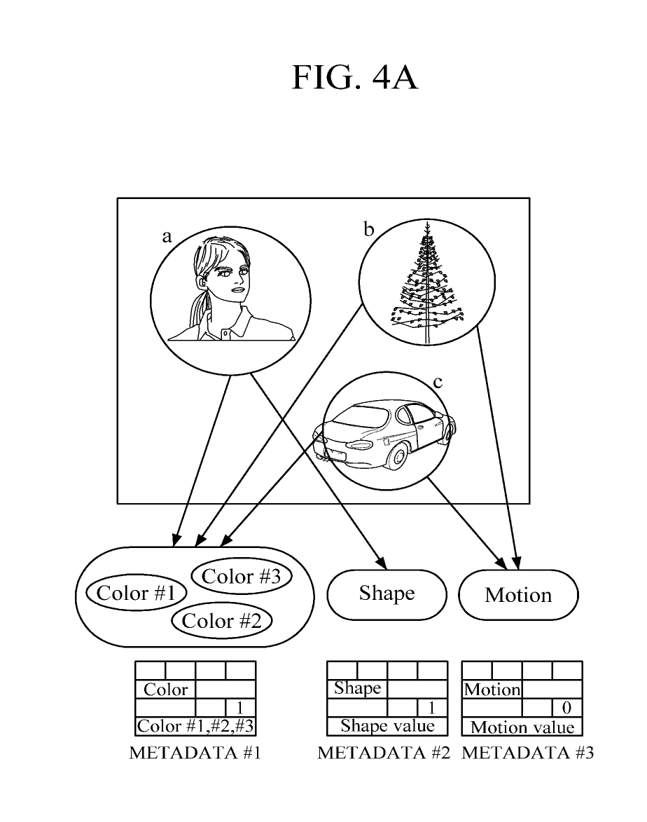

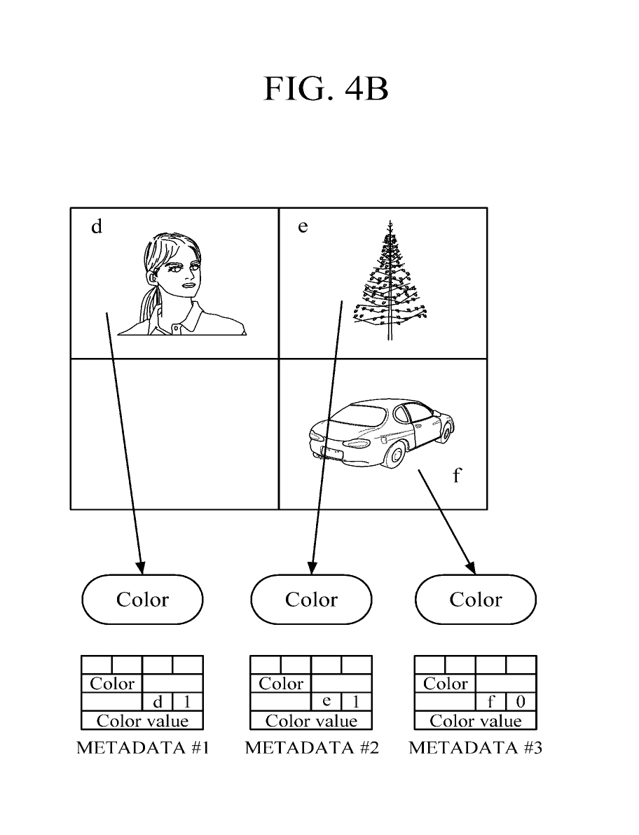

FIGS. 4A and 4B are illustrative diagrams illustrating a metadata structure of unstructured multimedia data.

Referring to 4A, three metadata having the same mapped time stamp are generated from an image. In metadata #1, the feature ID is “color,” and several attribute values of the color are extracted and described in the payload. In metadata #2, the feature ID is “shape” and in metadata #3, the feature ID is “motion.” Since these metadata have the same mapped time stamp, the constant indexes are represented as “1,” “1” and “0.”

Referring to 4B, three metadata having the same mapped time stamp are generated from an image. In the three metadata, respective feature IDs are “color” and the mapped location stamps are different. In other words, respective areas d, e and f are indicated in the mapped location stamps of the metadata. It is more effective for this indication of the areas to be realized through indexing in an internal DB table. Since these metadata have the same mapped time stamp, the constant indexes are represented as “1,” “1” and “0.”

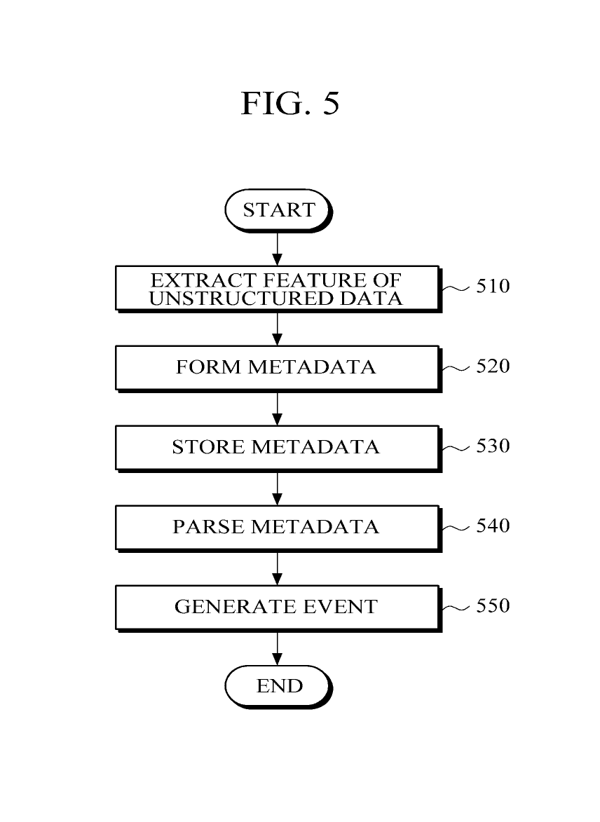

FIG. 5 is a flowchart illustrating a method of processing an unstructured data event in real time according to an embodiment of the present invention.

Referring to FIG. 5, the apparatus for processing an unstructured data event in real time first extracts a unique feature in order to structurize the unstructured data output from the plurality of unstructured data sensors 20-1, . . . , 20-n in operation 510. Here, the unique feature includes an attribute value such as a keyword or a tag in a web article or a color, a boundary, feel of a material, a position, a motion or the like in multimedia data.

The apparatus for processing an unstructured data event in real time selects primary data from each of the feature data of the unstructured data and the structured data output from the structured data sensor to form a plurality of metadata in operation 520. In this case, the apparatus forms the metadata by regularly changing the generation period of the time code of the unstructured data to be synchronized with the time code of the structured data and causing overlap data to have the same time code by describing multi attribute values of the overlap data in the payload. Since the unstructured data includes many overlap data, only data that do not overlap are separately extracted/summed up and processed so that a large number of overlap metadata are not generated. A structure of the metadata is as shown in FIG. 2.

The apparatus for processing an unstructured data event in real time stores the metadata formed in operation 530. Alternatively, the metadata may be transmitted to another network device in a packet format over a network.

The apparatus for processing an unstructured data event in real time parses the metadata in operation 540 and performs a process of generating an event defined according to the parsed metadata in operation 550.

Further, although not shown in the drawings, the apparatus for processing an unstructured data event in real time may register or update at least one of a predetermined criterion for extraction of the feature data, a predetermined criterion for selection of the primary data from among the extracted feature data, a parsing rule for parsing of the metadata, and an event processing rule defined according to the result of parsing the metadata.

According to the present invention, it is possible to constitute the real-time event processing apparatus that supports all data from structured data to unstructured data by newly forming various unstructured metadata, particularly, data of a multimedia format into structured metadata and processing the structured metadata. In other words, this means that meaningful information can be extracted from structured data used in an existing industrial sensor, as well as SNS-based large-capacity sporadic data, web data, or large-capacity multimedia data, through a real-time information parsing and processing system in real time.

With the present invention, it is possible to develop a real-time information parsing and event processing system capable of widely accommodating one-dimensional data, as well as sound data, two-dimensional video data, three-dimensional video data or the like, by first extracting primary feature information in a large-capacity data stream, newly re-forming space-time information within the extracted primary information as metadata, and performing structurization. Such metadata can be formed in a packet format in a network-based distributed system or may be transformed and formed in an XML-based tag format in a single-server-based distributed system, making it possible to flexibly cope with various system environments.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for processing an unstructured data event in real time, the apparatus comprising:
a feature extraction unit configured to extract predetermined feature data of unstructured data output from a plurality of unstructured data sensors;
a metadata forming unit configured to form the feature data of the unstructured data collected by the feature extraction unit as metadata including all attributes of the structured data and the unstructured data;
a metadata parser unit configured to parse the metadata formed by the metadata forming unit and continuously extract sensing data generated by the same sensor; and
an event processing unit configured to select only data corresponding to a predetermined rule from among the sensing data extracted by the metadata parser unit to generate an event.

2. The apparatus according to claim 1, further comprising a metadata database (DB),
wherein the metadata forming unit stores the formed metadata in the metadata DB, and
the metadata parser unit detects and parses the metadata stored in the metadata DB.

3. The apparatus according to claim 1, further comprising:
a rule updating unit configured to register or update a predetermined criterion for extraction of the feature data in the feature extraction unit.

4. The apparatus according to claim 1, further comprising:
a rule updating unit configured to register or update a predetermined criterion for selection of primary data from among the extracted feature data in the metadata forming unit.

5. The apparatus according to claim 1, further comprising:
a rule updating unit configured to register or update a parsing rule for parsing the metadata in the metadata parser unit.

6. The apparatus according to claim 1, further comprising:
a rule updating unit configured to register or update an event processing rule defined according to a result of parsing the metadata.

7. The apparatus according to claim 1, wherein the metadata includes, as attribute is information of the unstructured data, feature_ID for identifying the extracted feature data, a mapped time stamp obtained by transforming transformed a data indication time of the unstructured data in a format of structured data, a payload in which single feature data or multi feature data are indicated, and a mapped location stamp indicating a position value of Feature_ID in unstructured data of a multimedia format.

8. The apparatus according to claim 7, wherein the metadata further includes, as the attribute information of the unstructured data, a constant index for indicating continuity of a plurality of metadata when the plurality of metadata are generated in the same mapped time stamp.

9. The apparatus according to claim 8, wherein the constant index indicates continuous metadata as “1” or discontinuous metadata as “0.”

10. The apparatus according to claim 7, wherein the metadata forming unit forms the metadata by regularly changing a generation period of time code of the unstructured data to be synchronized with time code of structured data and causing overlap data to have the same time code by describing multi attribute values of the overlap data in a payload.

11. The apparatus according to claim 1, wherein the metadata forming unit deletes the overlap data among the unstructured data.

12. A method of processing an unstructured data event in real time, the method comprising:
extracting predetermined feature data of unstructured data output from a plurality of unstructured data sensors;
forming the feature data of the unstructured data as metadata including all attributes of the structured data and the unstructured data;
parsing the formed metadata; and
processing event generation defined by a result of the parsing.

13. The method according to claim 12, further comprising:
registering or updating a predetermined criterion for extraction of the feature data.

14. The method according to claim 12, further comprising:
registering or updating a predetermined criterion for selection of primary data from among the extracted feature data.

15. The method according to claim 12, further comprising:
registering or updating a parsing rule for parsing the metadata.

16. The method according to claim 12, further comprising:
registering or updating an event processing rule defined according to a result of parsing the metadata.

17. The method according to claim 12, wherein the forming of the feature data of the unstructured data as metadata includes forming the metadata by regularly changing a generation period of time code of the unstructured data to be synchronized with time code of structured data and causing overlap data to have the same time code by describing multi attribute values of the overlap data in a payload.

18. The method according to claim 12, wherein the forming of the feature data of the unstructured data as metadata includes deleting the overlap data among the unstructured data.
